(19) United States
(12) Patent Application Publication
(10) Pub. No.: US 2007/0088788 A1
(43) Pub. Date: Apr. 19, 2007

(54) Method and system for enhancing e-mail correspondence

(75) Inventors: Itzhack Goldberg, Hadera (IL); Gad Haber, Nesher (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/250,327

(22) Filed: Oct. 14, 2005

(51) Int. Cl. G06F 15/16

(52) U.S. Cl. 709/206

(57) ABSTRACT

A computer-implemented method and system for enhancing electronic mail (e-mail) correspondence is provided. The method includes, prior to sending an e-mail message, determining a status of a recipient of the e-mail message, and presenting the status to a user. The system includes an enhancement module to determine a status of a recipient of an e-mail message before the message is sent; and a database to store information about a previous recipients that received e-mail messages from a sender.

### FIELD OF THE INVENTION

The present invention relates generally to the field of electronic mail. In particular, the present invention relates to electronic mail systems that are designed to reduce the incidence of errors in transmitting electronic mail.

### BACKGROUND OF THE INVENTION

Since its introduction to the public in the late 20th century, e-mail has become a popular and widely used form of communication both at home and in the workplace. It is commonly used in research and engineering circles to share technical information, as well as by business people that use it, e.g., to negotiate, to enter into business transactions, etc. Additional professionals such as physicians, attorneys, and accountants also use it to communicate with their patients or clients.

Misdirecting, misrouting, or misaddressing sensitive e-mail messages such as business negotiations, correspondence with patient, etc., poses some risks to the sender of such messages, whether it is a private entity or an organization. For example, leakage of confidential information of an organization due to an e-mail message that was misaddressed to an unauthorized recipient may have dreadful consequences to the organization. Exposure of the future strategic plans of the organization to an unauthorized recipient, or permanent loss of trade secrets or other intellectual property rights are two examples of possible risks.

As a result, a large number of corporate and governmental organizations have implemented e-mail use policies for their employees, and many of these organizations have also set up some type of employee e-mail monitoring procedures or systems. But because of the amount of effort required, such procedures typically fall short of a detailed review of all messages sent by employees. Instead, an employee's e-mail is often only carefully evaluated once there is some indication that his or her communications present a risk or have already created a problem.

Systems have also been proposed that detect individual words or phrases without human intervention. But while these systems may be able to detect crude language usage or other potentially undesirable keyword patterns, language that is harassing or insulting, or that breaches an organization's confidentiality or creates other business risks, can be quite subtle.

Moreover, both human and automated pattern monitoring can be completely ineffective when applied to individual messages. This is because any particular message may only be viewed as objectionable or otherwise problematic in view of the context of other communications. And these other communications are often not available to the software, or even a human reviewer.

Furthermore, many e-mail utility applications support automatic completion of e-mail addresses that were previously used or of recipients that are listed in the address book coupled to these applications. User experience tests show that as a result of this function e-mail messages are sometime misaddressed and sent by mistake to the wrong recipients. Automatic systems or procedures typically do not detect such mistakes. Therefore, the use of e-mail by individuals or by employees of an organization can still pose a substantial risk.

### SUMMARY OF THE INVENTION

There is provided, in accordance with an embodiment of the present invention, a computer-implemented method for enhancing electronic mail (e-mail) transmission, the method includes, prior to sending an e-mail message, determining a status of a recipient of the e-mail message, and presenting the status to a user.

Also provided in accordance with another embodiment of the present invention, a system for enhancing e-mail transmission, the system includes an enhancement module to determine a status of a recipient of an e-mail message before the message is sent; and a database to store information about previous recipients that received e-mail messages from a sender.

Embodiments of the present invention also provide and computer software product implementing the above method.

### BRIEF DESCRIPTION OF THE DRAWINGS

Embodiments of the present invention will now be described, by way of examples only, with reference to the accompanying drawings in which:

FIG. 1 is a block diagram of a system for enhancing e-mail correspondence according to an embodiment of the present invention;

FIG. 2 is a block diagram of a history database and an enhancement module of the system for enhancing e-mail correspondence according to an embodiment of the present invention.

FIG. 3 is a screen view of a compound prompting dialog for the system of FIG. 1, in accordance with an embodiment of the present invention; and

FIG. 4 is a flow chart illustration of the e-mail correspondence enhancement process, in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that existing security systems or procedures fail to alert a user or an administrator that an e-mail is being sent by mistake to a valid recipient, whether the recipient listed in the sender's address book or not, is not the recipient that the sender actually referred to. Such mistakes may occur, for example, when the address of the wrong recipient is automatically completed from the user's address book.

Applicant has further realized that most of the e-mail communication a typical user has is with a defined group of correspondents, e.g., his or her manager, peers, colleagues, team members, clients, or patients, etc. in his or her work environment, or friends and family members for private e-mail communication. Put differently, typical e-mail users have a list of their “ordinary” correspondents, i.e., recipients that the user is in touch with in his or her ordinary way of communicating.

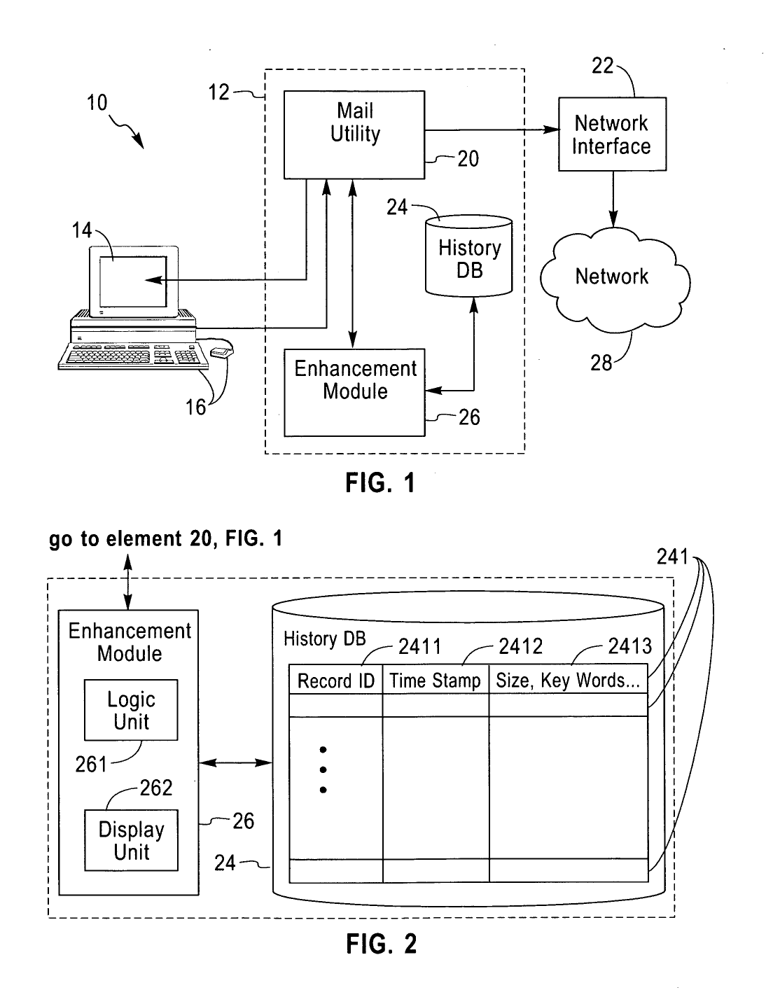

Reference is now made to FIG. 1 which is a block diagram of a system 10 for enhancing e-mail correspondence according to an embodiment of the present invention.

System 10 may include a mail system 12, a display 14, and a user input device 16, such as a mouse or keyboard. The local mailing system may include a mail utility 20, a network interface 22, a history database 24, and an enhancement module 26. The mail utility 20 in this embodiment may include an off-the-shelf mail application, such as Outlook®, commercially available from Microsoft Corporation of the USA, Lotus® Notes®, commercially available from International Business Machines Corporation of the USA, Eudora®, commercially available from Qualcomm, Inc., etc. The network interface 22 may be a communication facility allowing mail utility 20 to communicate mail messages to a network 28, such as the Internet, either directly or indirectly. The mailing system 12 may be implemented using software running on one or more computers, such as a personal computer or a network of personal computers. These computers may run an off-the-shelf operating system. One of ordinary skill would recognize, however, that numerous other implementations are also possible. The exact makeup of such implementations will depend on desired user interface and messaging features, the nature of the communications network used by the system, available technology, and a variety of other variables.

History database 24 may be included in one or more data storage areas, such as disk or integrated circuit storage areas, that are accessible to mail utility 20 for the storage of information related to the recipients of messages sent from the mail utility 20. The information may include details about the recipients that may be used to determine how frequent the recipient receives e-mail massages from the user of mail utility 20, as will be described in detail below.

Enhancement module 26 may be an application extension that interacts with history database 24 and with the mail utility 20 to provide additional mail-related features, such as alerts as will be described in detail below. This interaction may take place through a formal interface known as an Application Programming Interface (API). Other implementations of the mailing system 12 are also possible, however, such as systems that include a single application combining the functions of the mail utility and enhancement module, or systems that employ enhancement modules that interact with messages after they have left the mail utility.

Reference is now made to FIG. 2 which is a more detailed block diagram of history database 24 and enhancement module 26 of system 10 described above for enhancing e-mail correspondence according to an embodiment of the present invention. Enhancement module may include a control unit 261 that may receive the message sent by the user as input, and a display unit 262 that may prompt and alert the user as will be described in detail below. Control unit 261 may send queries to history database 24 based on the recipients of the message to determine whether a recipient is considered as an “ordinary” recipient or a new one.

History database 24 may store history information about the recipients that received messages from the user of system 10. For example, history database 24 may include records 241 of the recipients that received messages from the user. Alternatively, the database may include records of the messages that were sent by the user. In the example shown in FIG. 2 the records are structured in a table but it should be noted that the records may be stored in any known form of a data structure, e.g., list, array, linked list, hash table, graph, etc.

In the example of FIG. 2, history database 24 includes records 241 of recipients that received message from the sender. Each record may include, for example, a record identifier 2411, such as the recipient name, his or her e-mail address, employee ID, or any other unique ID. In addition, each record may include a time stamp 2412, e.g., the date the record was last updated in the database. This date may indicate when was the last time the recipient listed in this record received a message from the user. Additional details 2413 for each record may include the size of the message sent to the recipients, key words associated with the message, how frequent this recipient receives e-mail message from the user of system 10, etc. It should be noted that each record may also include a link or a pointer to the message that originated the record.

As mentioned above, control unit 261 may send the queries to history database 24. Upon receipt of the query results, control unit 261 may prompt alerts to the user of system 10, based on a policy defined by the user or the administrator, as will be described in detail below.

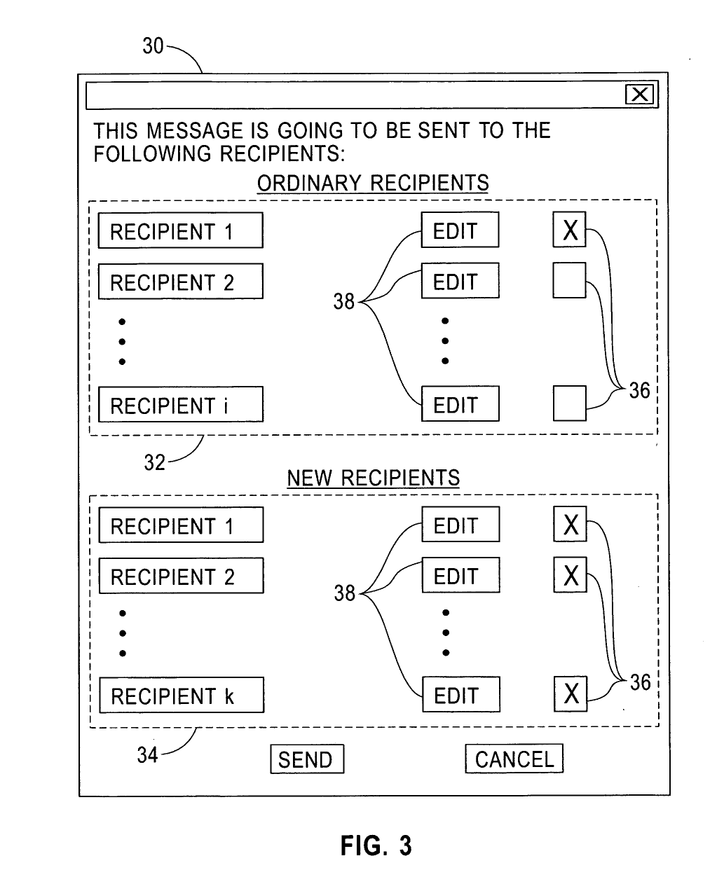

Reference is now made to FIG. 3 which is a screen view of a compound prompting dialog 30 for the system of FIG. 1, in accordance with an embodiment of the present invention. Enhancement module 26 may present dialog 30 to the user once the user indicates that the message can be sent, e.g., by clicking a “send” button, and before the mail utility 20 actually sends it. The dialog 30 may include a list 32 of recipients 32_{[1]}-32_{[i]}, whose status is “ordinary” or “common”, and a list 34 of recipients 34_{[1]}-34_{[j]} with a different status of “new” or “non-ordinary”. The details presented for each recipient are identifying details such as, for example, the e-mail address of the recipient, or any other detail that may be stored in history database 24 to identify the recipient, such as unique ID, employee number, etc., as discussed above.

Near each recipient there is a confirmation button or checkbox 36, and an “edit” button 38. Dialog 30 may also include a “send” and “cancel” buttons to actually send the message after reviewing the lists of the recipients and making changes if such changes are required. The decision whether a recipient should be listed in list 32 or 34 may be made in various ways as will be described in detail below.

According to one exemplary embodiment of the present invention, and as previously discussed, history database 24 may store history information about the recipients that received e-mail messages from the user of system 10. The information stored in the database may be analyzed according to a history policy that may be used to determine whether a recipient is an “ordinary” recipient or a new one. For example, a threshold timeframe, e.g., of the last 30 days, may be defined by the user or by an administrator. Accordingly, when the logic unit 261 (see FIG. 2) in enhancement unit 26 detects that a message is sent to a recipient whose record in the history database 24 has a timestamp older than the threshold (or to a recipient not stored in the database), the recipient may be listed in new recipient list 34.

According to a second exemplary embodiment of the present invention, history database 24 may store additional information about the recipients other than the last time that a message was sent to them, and the user or the administrator of system 10 may define rules to decide whether a recipient should be included in list 32 of the “ordinary” recipients based on this additional information. This additional information may include a rate of receiving a mail, e.g., how often the recipient receives a message from the user. In addition, history database 24 may hold information related to the content of the messages sent through mail utility 20. Simple details related to the content may include the size of the message, whether it included attachments and of what type, whether there were additional recipients to that message, and their details. More complicated details may include, for example, key words in the message sent, the subject of the message, etc. These details may be obtained, for example, by implementing indexing methods such as the methods that are described in U.S. patent application Ser. No. 11/135,818, titled “A METHOD AND SYSTEM FOR MANAGING FILES IN A FILE SYSTEM”, which is assigned to the common assignee of the present patent application.

Accordingly, the user or the administrator of system 10 may define rules to decide whether a recipient should be included in list 32 of the “ordinary” recipients. For example, if one e-mail message per week is sent to recipient X, then when a second e-mail message is sent to that recipient in the same week, the recipient will be listed in new recipient list 34. According to another example, if recipient Y receives only text messages without attachments at all, then when a message with an attachment is sent to him, he will be listed in new recipient list 34 as well. According to yet another example, if recipient Z receives messages with keywords such as “family”, “trips” and “weekend”, then when recipient Z receives a message with different keywords such as “confidential”, “engagement”, the recipient should be listed in new recipient list 34. It should be noted that these are only examples, and that the rules may be defined dynamically according to additional information that may be stored in database 24.

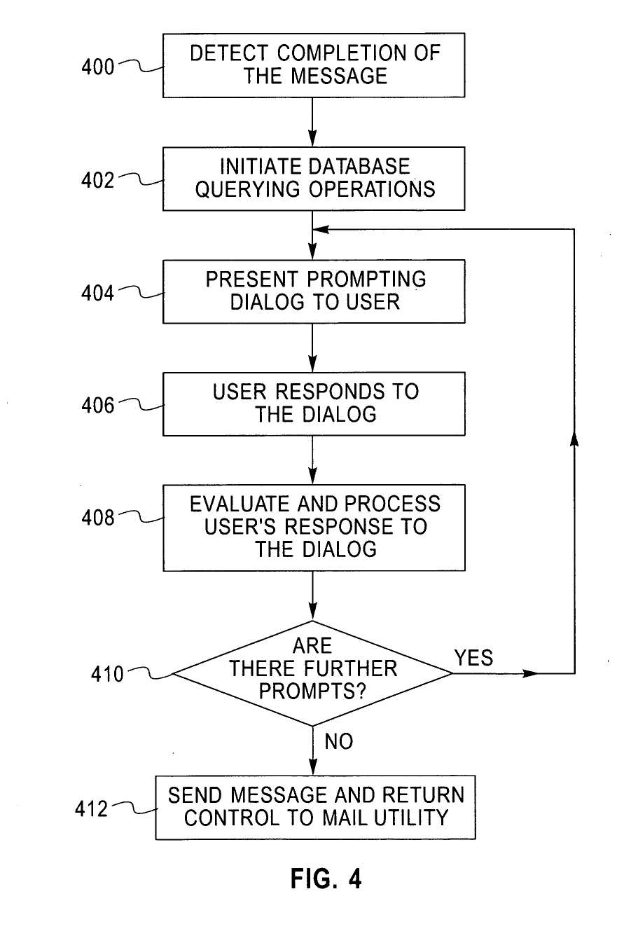

Reference is now made to FIG. 4 which is a flow chart illustration of the e-mail correspondence enhancement process, in accordance with embodiments of the present invention.

The process may begin with a user preparing a message to be sent, using, for example, the mail editing functions of the mail utility 20. Once the user is satisfied with the contents and addressing of the message, he or she may actuate a control indicating that he or she has finished editing the message and is ready to send it. The detection (step 400) of the message completion event may cause the system to initiate (step 402) its database querying operations. Then, the system may assemble a prompting dialog, and may present it (step 404) to the user. The user may respond (step 406) to the dialog in some way, such as may confirm sending the message to all or some of the recipients listed in lists 32 and 34, may edit the e-mail address of some of the recipients, may cancel sending the message to some of the recipients, etc.

The system may then evaluate and process (step 408) the user's response to the dialog to determine whether an acceptable response was made, such as the clicking on an OK button. If the user actuates a cancel-type button, the message will not be sent, and the user will be returned to mail utility 20. If the user actuates a correct-type button, such as an edit button or an open button, the user will be presented with an appropriate interface to perform the correction, such as an editing window.

After completion of the prompting function(s) carried out by the prompting dialog, the system may determine (step 410) whether further prompts remain. If no further prompts remain, the system may send (step 412) the message and return control to the mail utility. If further prompts remain, the system may repeat (steps 404-410) the prompting process until either the user cancels, or there are no more prompting dialogs to be presented.

In the description above, numerous specific details were set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code that embodies aspects of the present invention is typically maintained in permanent storage, such as a computer readable medium. In a client-server environment, such software programming code may be stored on a client or server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

Improvements and modifications can be made to the foregoing without departing from the scope of the present invention.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A computer-implemented method for enhancing electronic mail (e-mail) transmission, the method comprising:
prior to sending an e-mail message, determining a status of a recipient of said e-mail message; and
presenting said status to a user.

2. The method according to claim 1, wherein said determining further comprises determining, based on a history policy, whether said recipient ordinarily receives e-mails from a sender of said e-mail message.

3. The method according to claim 2, wherein said determining further comprises analyzing the history information of said sender to determine whether said recipient ordinarily receives e-mails from said sender.

4. The method according to claim 3, wherein said analyzing further comprising:
comparing said recipient to a database indicative of recipients that received e-mail from said sender;
responsive to said history policy, determining whether the status of said recipient is new or ordinary.

5. The method according to claim 4, wherein the identity of said recipient and a time stamp the last message was sent to said recipient are stored in said database.

6. The method according to claim 5, wherein according to said history policy, recipients with a time stamp older than a dynamically defined threshold time stamp are determined as new recipients.

7. The method according to claim 4, wherein additional information about the characteristics of messages said recipient receives from said sender is stored in said database.

8. The The method according to claim 7, wherein according to said history policy, recipients of messages with different characteristics than the characteristics-stored in said database, are determined as new recipients.

9. A system for enhancing e-mail transmission, the system comprising:
an enhancement module to determine a status of a recipient of an e-mail message before said message is sent; and
a database to store information about previous recipients that received e-mail messages from a sender.

10. The system according to claim 9, wherein said enhancement module determines whether said recipient ordinarily receives e-mails from a sender of said e-mail message, based on a history policy.

11. The method according to claim 10, wherein said enhancement module analyzes the history information of said sender stored on said database to determine whether said recipient ordinarily receives e-mails from said sender.

12. The system according to claim 9, wherein said status of said recipient is new or ordinary.

13. The system according to claim 10, wherein the identity of said recipient and a time stamp the last message was sent to said recipient are stored in said database.

14. The system according to claim 13, wherein said enhancement module determines, according to said history policy, that recipients with a time stamp older than a dynamically defined threshold time stamp are new recipients.

15. The system according to claim 9, wherein additional information about the characteristics of messages said recipient receives from said sender is stored in said database.

16. The system according to claim 15, wherein said enhancement module determines, according to said history policy, that recipients of messages with different characteristics than the characteristics stored in said database, are new recipients.

17. A computer software product, including a computer-readable medium in which computer program instructions are stored, which instructions, when read by a computer, cause the computer to perform a method method for enhancing electronic mail (e-mail) transmission, the method comprising:
prior to sending an e-mail message, determining a status of a recipient of said e-mail message; and
presenting said status to a user.

18. The method according to claim 17, wherein said determining further comprises determining, based on a history policy, whether said recipient ordinarily receives e-mails from a sender of said e-mail message.

19. The method according to claim 18, wherein said determining further comprises analyzing the history information of said sender to determine whether said recipient ordinarily receives e-mails from said sender.

20. The method according to claim 19, wherein said analyzing further comprising:
comparing said recipient to a database indicative of recipients that received e-mail from said sender;
responsive to said history policy, determining whether the status of said recipient is new or ordinary.
